(19) United States
(12) Patent Application Publication
(10) Pub. No.: US 2021/0064226 A1
(43) Pub. Date: Mar. 4, 2021

(54) CONTROL DEVICE AND CONTROL METHOD

(71) Applicant: FANUC CORPORATION, Minamitsuru-gun (JP)

(72) Inventor: Satoshi UCHIDA, Yamanashi (JP)

(21) Appl. No.: 16/983,327

(22) Filed: Aug. 3, 2020

(30) Foreign Application Priority Data
Aug. 29, 2019 (JP) 2019-156352

(51) Int. Cl. G06F 3/0484; G06F 3/0488; G06F 3/0481; G06F 3/0482

(52) U.S. Cl. CPC G06F 3/04847; G06F 3/04886; G06F 3/04842; G06F 3/0482; G06F 3/04817

(57) ABSTRACT

A control device includes: a screen display information acquisition unit that acquires screen display information on a screen displayed on a display device; a selectable information acquisition unit that acquires selectable information of the screen and a position of the selectable information; a mark allocation unit that allocates marks corresponding to respective pieces of acquired selectable information; a screen display processing unit that displays the screen in which the marks allocated on the basis of the position of the selectable information are superimposed on the display device; a soft key changing unit that changes marks to be appended to soft keys; and a soft key display processing unit that displays the soft keys on the display device, wherein when a hard key corresponding to the soft key is pressed, the selectable information corresponding to the mark appended to the soft key is displayed on the display device.

This application is based on and claims the benefit of priority from Japanese Patent Application No. 2019-156352, filed on 29 Aug. 2019, the content of which is incorporated herein by reference.

### BACKGROUND OF THE INVENTION

### Field of the Invention

The present invention relates to a control device and a control method.

### Related Art

For example, some control devices for controlling industrial machines are used for a long period (for example, 10 years or more) once they are introduced. Therefore, some control devices that are currently operating are unable to connect a pointing device such as a mouse thereto and have a display device that does not have a touch panel.

As illustrated in FIG. 9, for example, in such a control device, a display unit 10 such as a liquid crystal display included in a display device 100 has a region (hereinafter also referred to as a “screen display region 20”) for displaying a screen and a region (hereinafter also referred to as a “soft key display region 30”) for displaying soft keys 31(1) to 31(n) which are an input device realized in software. n is a positive integer. Hard keys 40(1) to 40(n) disposed below the display unit 10 so as to correspond to the soft keys 31(1) to 31(n) to select the soft keys 31(1) to 31(n) are disposed in the display device 100. In this way, when a user presses the hard key 40(1), the corresponding soft key 31(1) is selected, and the control device executes an operation allocated to the selected soft key 31(1).

When it is not necessary to distinguish the individual soft keys 31(1) to 31(n), these soft keys will be collectively referred to as a “soft key 31”. When it is not necessary to distinguish the individual hard keys 40(1) to 40(n), these soft keys will be collectively referred to as a “hard key 40”.

Hereinafter, although a case where n=10 is described, the same operation is applied to a case where n is a plural number other than 10. Although the hard keys 40(1) to 40(n) are disposed below the display unit 10, there is no limitation thereto and the hard keys may be disposed at an arbitrary position around the display unit 10.

However, for example, when the display device 100 of FIG. 9 displays a screen created by hypertext markup language (HTML) or the like in the screen display region 20, it is difficult to directly select information of a hyperlink or the like on the screen.

In this regard, a technique in which when a focused field changes when a user scrolls a browser screen, a uniform resource locator (URL) or the like of a hyperlink of the focused field is automatically allocated to a soft key is known. For example, see Patent Document 1.

Patent Document 1: Japanese Unexamined Patent Application (Translation of PCT Application), Publication No. 2002-510819

### SUMMARY OF THE INVENTION

FIG. 10 is a diagram illustrating an example of a method of selecting a hyperlink on a screen of the display device 100 of FIG. 9.

As illustrated in FIG. 10, for example, when a user wants to move the focus from a focused hyperlink H1 indicated by a broken-line rectangle to a hyperlink H5, the user moves the focus by pressing an arrow key or a tab key included in a manual data input (MDI) (not illustrated). The user presses an enter key of the MDI (not illustrated) whereby the information of the hyperlink H5 is displayed in the screen display region 20.

However, in this method, the user needs to press the arrow key and the like a plurality of times, which is troublesome.

Therefore, it is desirable to perform operations easily in a display device which does not have a mouse, a touch panel, or the like.

(1) An aspect of a control device of the present disclosure is a control device that controls display of a display device displaying soft keys for operating the control device that controls an industrial machine and having hard keys disposed to correspond to the soft keys to select the soft keys, including: a screen display information acquisition unit that acquires screen display information on a screen displayed on the display device; a selectable information acquisition unit that acquires selectable information which can be selected on the screen displayed on the display device and a position of the selectable information on the basis of the acquired screen display information; a mark allocation unit that allocates marks corresponding to respective pieces of acquired selectable information; a screen display processing unit that displays the screen in which the marks allocated on the basis of the position of the selectable information are superimposed on the display device; a soft key changing unit that changes marks to be appended to the soft keys according to the allocation by the mark allocation unit; and a soft key display processing unit that displays the soft keys on the display device, wherein when the hard key corresponding to the soft key is pressed, the selectable information corresponding to the mark appended to the soft key is displayed on the display device.

(2) An aspect of a control method of the present disclosure is a control method for controlling display of a display device displaying soft keys for operating the control device that controls an industrial machine and having hard keys disposed to correspond to the soft keys to select the soft keys, the method being realized by a computer and including: acquiring screen display information on a screen displayed on the display device; acquiring selectable information which can be selected on the screen displayed on the display device and a position of the selectable information on the basis of the acquired screen display information; allocating marks corresponding to respective pieces of acquired selectable information; displaying the screen in which the marks allocated on the basis of the position of the selectable information are superimposed on the display device; changing marks to be appended to the soft keys according to the allocation of the marks; and displaying the soft keys on the display device, wherein when the hard key corresponding to the soft key is pressed, the selectable information corresponding to the mark appended to the soft key is displayed on the display device.

According to an aspect, it is possible to perform operations easily in a display device which does not have a mouse, a touch panel, or the like.

### BRIEF DESCRIPTION OF THE DRAWINGS

FIG. 1 is a functional block diagram illustrating a functional configuration example of a control system according to an embodiment.

FIG. 2 is a diagram illustrating an example in which marks are displayed on a screen in a superimposed manner.

FIG. 3 is a diagram illustrating an example of a case in which the screen of FIG. 2 is scrolled.

FIG. 4 is a diagram illustrating an example of a screen in which buttons, checkboxes, radio buttons, list boxes, and text boxes are displayed to be superimposed on marks.

FIG. 5 is a diagram illustrating an example of a screen when a list box is expanded.

FIG. 6 is a diagram illustrating an example of a screen in which tabs and trees are displayed to be superimposed on marks.

FIG. 7 is a diagram illustrating an example of a screen in which a tree is expanded.

FIG. 8 is a flowchart illustrating a display process of a control device.

FIG. 9 is a diagram illustrating an example of a display device that does not have a mouse, a touch panel, and the like.

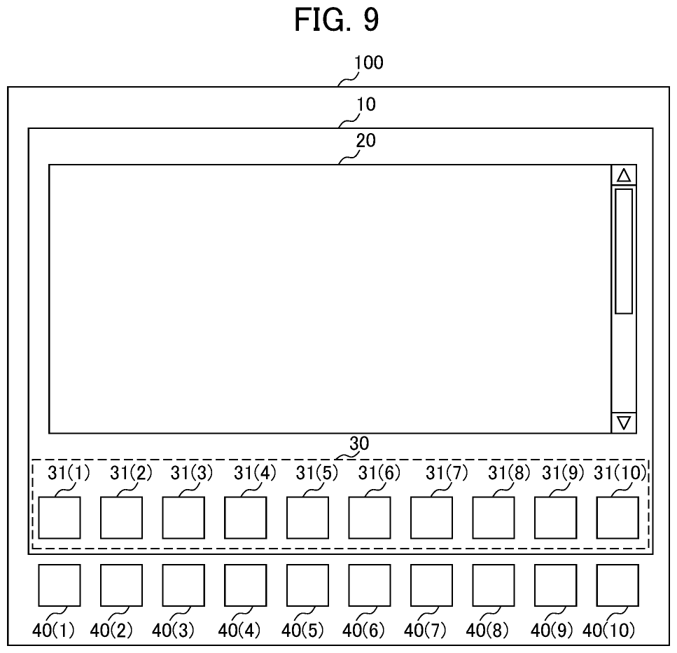

FIG. 10 is a diagram illustrating an example of a method of selecting a hyperlink on a screen of a display device of FIG. 9.

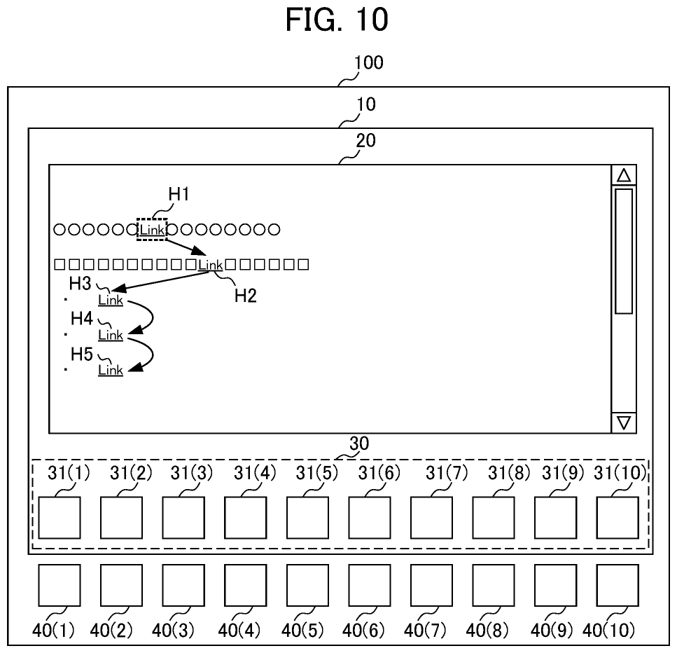

### DETAILED DESCRIPTION OF THE INVENTION

Hereinafter, an embodiment of the present disclosure will be described with reference to the drawings.

### Embodiment

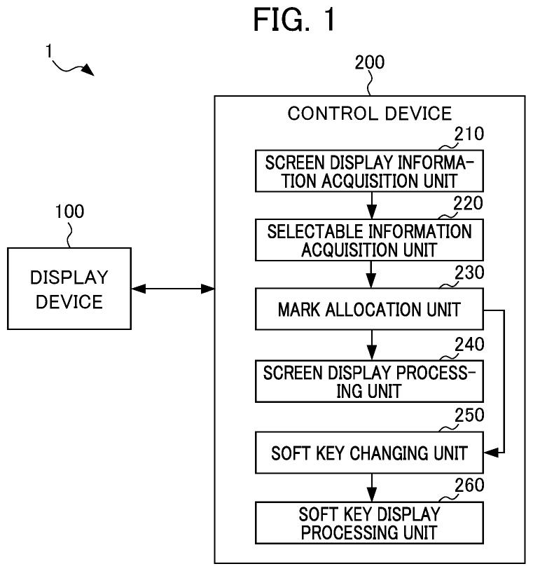

FIG. 1 is a functional block diagram illustrating a functional configuration example of a control system 1 according to an embodiment.

As illustrated in FIG. 1, the control system 1 includes a display 100 and a control device 200.

The display device 100 and the control device 200 may be connected directly to each other via a connection interface (not illustrated). The display device 100 and the control device 200 may be connected to each other via a network (not illustrated) such as a local area network (LAN) or the Internet. In this case, the display device 100 and the control device 200 have a communication unit (not illustrated) for performing communication each other using the connection. The display device 100 may be included in the control device 200.

### Control Device 200

The control device 200 is a numerical controller that is well known to those skilled in the art, and generates an operation command on the basis of control information and transmits the generated operation command to a machine tool (not illustrated). In this way, the control device 200 controls operations of the machine tool (not illustrated). When the machine tool is a robot, the control device 200 may be a robot controller or the like.

A control target of the control device 200 is not limited to a machine tool and a robot, but the control device 200 may be broadly applied to all industrial machines. An industrial machine includes various machines such as a machine tool, an industrial robot, a service robot, a forging machine, and an injection molding machine.

As illustrated in FIG. 1, the control device 200 controls the display of the display device 100 for displaying soft keys 31. Therefore, the control device 200 includes a screen display information acquisition unit 210, a selectable information acquisition unit 220, a mark allocation unit 230, a screen display processing unit 240, a soft key changing unit 250, and a soft key display processing unit 260.

The control device 200 includes an arithmetic processing unit (not illustrated) such as a central processing unit (CPU) in order to realize the operations of the functional blocks in FIG. 1, for example. The control device 200 includes an auxiliary storage device (not illustrated) such as a read only memory (ROM) and a hard disk drive (HDD) storing various control programs and a main storage device (not illustrated) such as a random access memory (RAM) for storing data which is temporarily necessary for an arithmetic processing device to execute programs.

In the control device 200, the arithmetic processing device reads application software and an OS from the auxiliary storage device and performs an arithmetic process based on the application software and the OS while deploying the read application software and OS on the main storage device. The control device 200 controls various hardware components on the basis of the arithmetic processing result. In this way, the processes of the functional blocks in FIG. 1 are realized. That is, the control device 200 can be realized by cooperation of hardware and software.

The screen display information acquisition unit 210 acquires screen display information on a screen displayed on the display device 100.

Specifically, the screen display information acquisition unit 210 acquires information on files such as a HTML file of a screen displayed on the screen display region 20 as the screen display information, for example. When a new screen different from a screen being displayed presently is displayed according to a user operation or a system process, for example, the screen display information acquisition unit 210 acquires screen display information of the screen displayed newly.

The selectable information acquisition unit 220 acquires selectable information which can be selected on the screen displayed in the screen display region 20 and the position of the selectable information on the basis of the screen display information of the screen acquired by the screen display information acquisition unit 210.

Specifically, the selectable information acquisition unit 220 acquires the location of a hyperlink indicated by “<a href=“”></a>” in the screen display information of the screen as the selectable information, for example. The selectable information acquisition unit 220 acquires the position of each piece of selectable information acquired on the displayed screen.

The selectable information is not limited to a hyperlink. The selectable information may include a user interface (UI) control. A UI controller includes buttons, checkboxes, radio buttons, list boxes, text boxes, tabs, and trees. The selectable information is not limited to the above-described examples.

The mark allocation unit 230 allocates corresponding marks to the respective pieces of selectable information acquired by the selectable information acquisition unit 220.

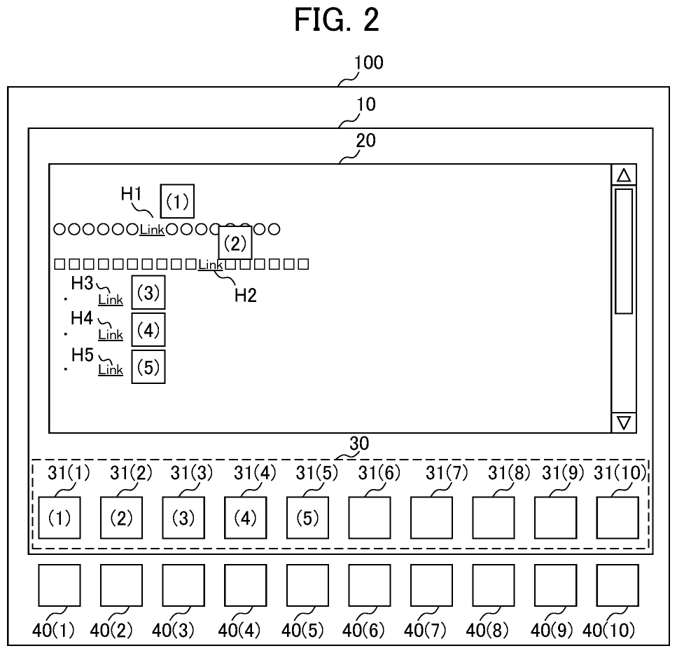

Specifically, for example, as illustrated in FIG. 2, the mark allocation unit 230 allocates marks of the numbers “1” to “5” to the respective pieces of selectable information which are hyperlinks H1 to H5 included in the screen.

Although the marks are the numbers “1” to “5”, the marks may be characters such as alphabet, figures such as a triangle or a heart icon, or a combination thereof.

As illustrated in FIG. 2, the screen display processing unit 240 displays a screen in which marks allocated on the basis of the position of the selectable information are superimposed in the screen display region 20.

The soft key changing unit flu changes a mark appended to the soft key 31 according to the allocation by the mark allocation unit 230.

Specifically, as illustrated in FIG. 2, the soft key changing unit 250 appends marks of the numbers “1” to “5” to five soft keys 31(1) to 31(5). The soft key changing unit 250 leaves the marks blank for the remaining five soft keys 31(6) to 31(10) to which no marks are allocated.

The soft key display processing unit 260 displays the soft keys 31 in the soft key display region 30.

Specifically, as illustrated in FIG. 2, the soft key display processing unit 260 displays the soft keys 31(1) to 31(5) to which the marks of the numbers “1” to “5” are appended. The soft key display processing unit 260 displays the blank soft keys 31(6) to 31(10) to which no marks are allocated.

By doing so, when the user presses the hard key 40(5) corresponding to the soft key 31(5) of the number “5”, the hyperlink H5 corresponding to the mark of the number “5” is selected and input. As a result, a screen of the information of the selected link destination is displayed in the screen display region 20.

In this way, in the display device 100 that does not have a mouse or a touch panel, the user can display information of a desired link destination easily by a screen operation of pressing the hard key 40 once.

Next, some examples of a case where a new screen is displayed in the screen display region 20 according to a user's operation or a system process will be described. Hereinafter, (a) a case where a screen is switched, (b) a case where a list box included in a screen is expanded, and (c) a case where a tree included in a screen is expanded will be described.

### (a) Case Where Screen is Switched

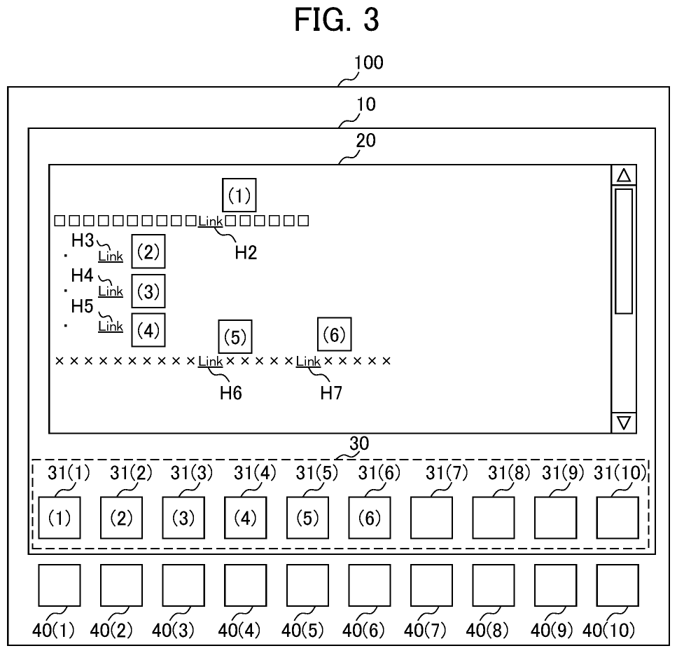

FIG. 3 is a diagram illustrating an example of a case where the screen of FIG. 2 is scrolled.

As illustrated in FIG. 3, for example, as a screen displayed newly when the screen of FIG. 2 is scrolled up according to a user's operation, a line including the hyperlink H1 is not displayed, and a new line including hyperlinks H6 and H7 is displayed.

In this case, the screen display information acquisition unit 210 acquires the screen display information of the screen when the screen is scrolled. The selectable information acquisition unit 220 acquires the selectable information and the position of the selectable information on the basis of the screen display information of the screen. The mark allocation unit 230 reallocates the marks of the numbers “1” to “6” to the hyperlinks H2 to H7 which are the acquired pieces of selectable information. The screen display processing unit 240 displays a screen in which the marks of the numbers “1” to “6” reallocated on the basis of the position of the selectable information are superimposed in the screen display region 20.

The soft key changing unit 250 changes the marks to be appended to the soft keys 31(1) to 31(6) to the numbers “1” to “6” according to the reallocation by the mark allocation unit 230. The soft key display processing unit 260 displays the soft keys 31(1) to 31(6) to which the marks of the numbers “1” to “6” are appended in the soft key display region 30.

Although a case of scroll has been described as switching of screen, the same is applied to a case of screen transition.

### (b) Case Where a List Box Included in Screen is Expanded

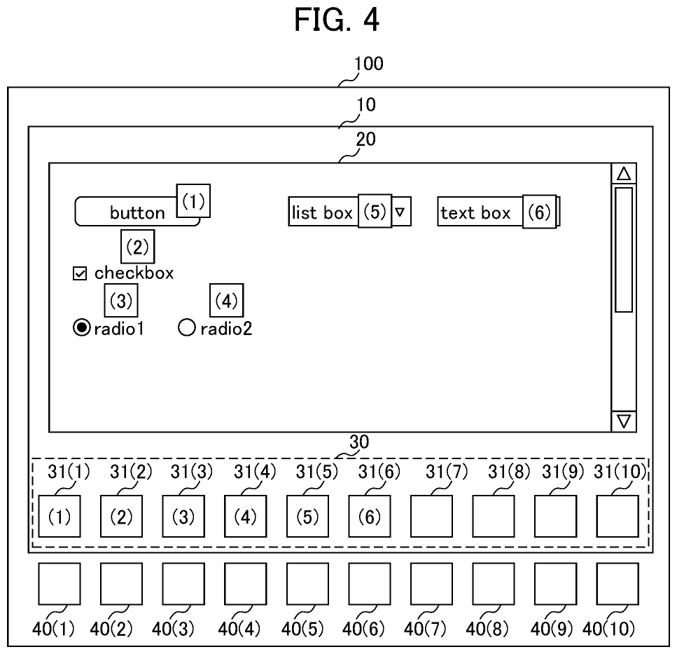

FIG. 4 is a diagram illustrating an example of a screen in which buttons, checkboxes, radio buttons, list boxes, and text boxes are displayed to be superimposed on marks.

As illustrated in FIG. 4, the mark allocation unit 230 allocates the marks of the numbers “1” to “6” so as to correspond to a button, a checkbox, a radio button, a list box, and a text box as the acquired selectable information, The screen display processing unit 240 displays a screen in which the marks of the numbers “1” to “6” allocated on the basis of the position of the selectable information are superimposed in the screen display region 20.

The soft key changing unit 250 changes the marks to be appended to the soft keys 31(1) to 31(6) to the numbers “1” to “6” according to the allocation by the mark allocation unit 230. The soft key display processing unit 260 displays the soft keys 31(1) to 31(6) to which the marks are appended in the soft key display region 30.

After that, for example, when the user presses the hard key 40(5) corresponding to the soft key 31(5) of the number “5” to select a list box corresponding to the mark of the number “5”, the list box is expanded. As a result, a screen including the selectable information of the expanded list box is displayed in the screen display region 20.

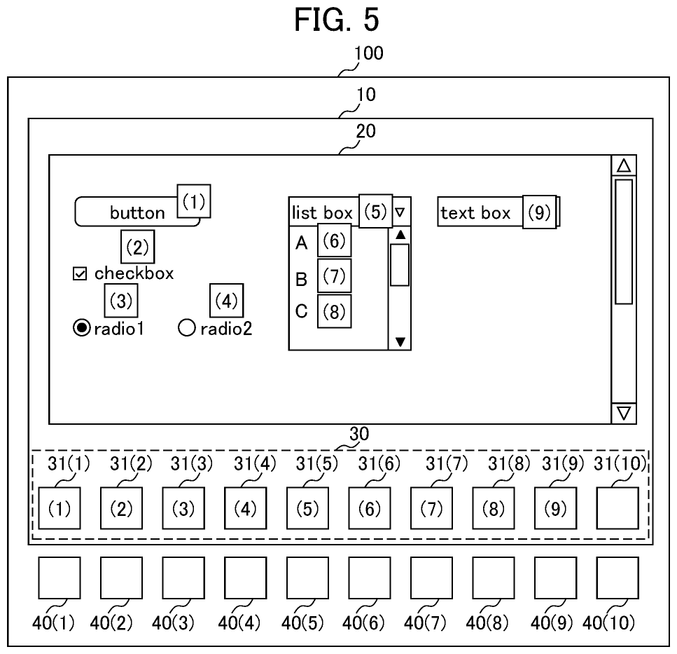

FIG. 5 is a diagram illustrating an example of a screen in which a list box is expanded.

As illustrated in FIG. 5, when the list box corresponding to the mark of the number “5” is selected, the list box is expanded, and for example, the pieces of selectable information “A”, “B”, and “C” included in the list box are displayed.

In this case, the screen display information acquisition unit 210 acquires the screen display information of the screen in which the list box is expanded. The selectable information acquisition unit 220 acquires the selectable information and the position of the selectable information on the basis of the screen display information of the screen. The mark allocation unit 230 reallocates the marks of the numbers “1” to “9” so as to correspond to all pieces of selectable information on the screen including the selectable information of the list box displayed due to expansion. The screen display processing unit 240 displays a screen in which the marks of the numbers “1” to “9” reallocated on the basis of the position of the selectable information are superimposed in the screen display region 20.

The soft key changing unit 250 changes the marks to be appended to the soft keys 31(1) to 31(9) to the numbers “1” to “9” according to the reallocation by the mark allocation unit 230. The soft key display processing unit 260 displays the soft keys 31(1) to 31(9) to which the marks are appended in the soft key display region 30.

In FIG. 4, when the user presses the hard key 40(6) corresponding to the soft key 31(6) of the number “6” to select a text box corresponding to the mark of the number “6”, the screen display processing unit 240 may move a cursor to the selected text box.

### (c) Case Where Tree Included in Screen is Expanded

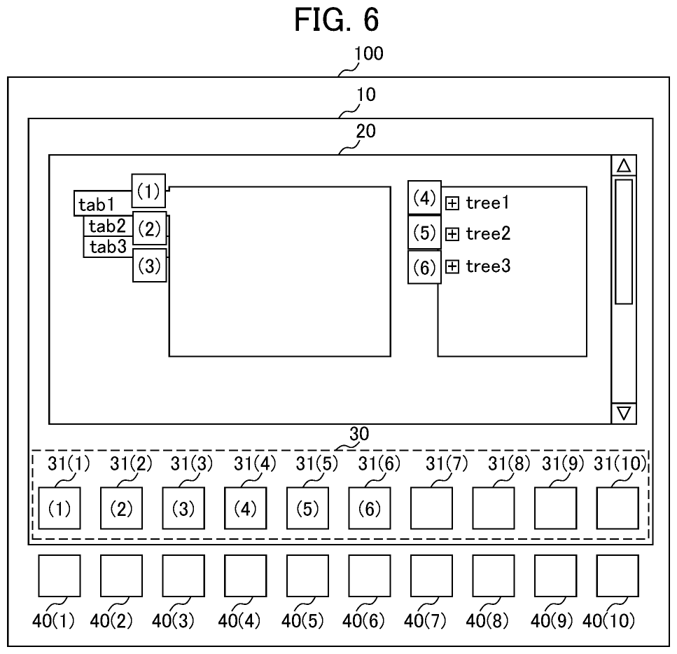

FIG. 6 is a diagram illustrating an example of a screen in which tabs and trees are displayed to be superimposed on marks.

As illustrated in FIG. 6, the mark allocation unit 230 allocates the marks of the numbers “1” to “6” corresponding to the tabs of “tab1”, “tab2”, and “tab3” and trees of “tree1”, “tree2”, and “tree3” as the acquired selectable information. The screen display processing unit 240 displays a screen in which the marks of the numbers “1” to “6” allocated on the basis of the position of the selectable information are superimposed in the screen display region 20.

The soft key changing unit 250 changes the marks to be appended to the soft keys 31(1) to 31(6) to the numbers “1” to “6” according to the allocation by the mark allocation unit 230. The soft key display processing unit 260 displays the soft keys 31(1) to 31(6) to which the marks are appended in the soft key display region 30.

After that, for example, when the user presses the hard key 40(4) corresponding to the soft key 31(4) of the number “4” to select the tree of “tree1” corresponding to the mark of the number “4”, the tree of “tree1” is expanded. As a result, a screen including the selectable information of the expanded tree of “tree1” is displayed in the screen display region 20.

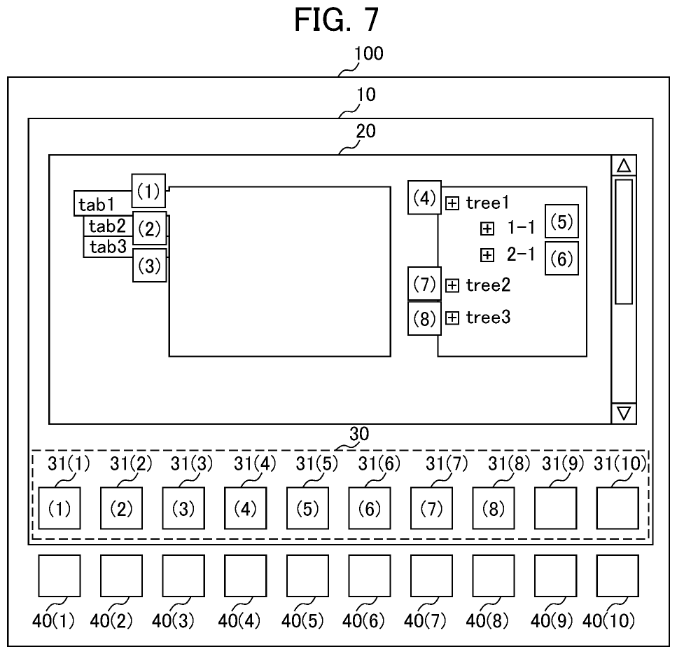

FIG. 7 is a diagram illustrating an example of a screen in which a tree is expanded.

As illustrated in FIG. 7, the tree of “tree1” is expanded whereby pieces of selectable information “1-1” and “2-1” included in the tree of “tree1”, for example, are displayed in the screen.

In this case, the screen display information acquisition unit 210 acquires the screen display information of the screen in which the tree is expanded. The selectable information acquisition unit 220 acquires the selectable information and the position of the selectable information on the basis of the screen display information of the screen. The mark allocation unit 230 reallocates the marks of the numbers “1” to “8” so as to correspond to all pieces of selectable information on the screen including the selectable information of the tree of “tree1” displayed due to expansion. The screen display processing unit 240 displays a screen in which the marks of the numbers “1” to “8” reallocated on the basis of the position of the selectable information are superimposed in the screen display region 20.

The soft key changing unit 250 changes the marks to be appended to the soft keys 31(1) to 31(8) to the numbers “1” to “8” according to the reallocation by the mark allocation unit 230. The soft key display processing unit 260 displays the soft keys 31(1) to 31(8) to which the marks are appended in the soft key display region 30.

### Display Process of Control Device 200

Next, an operation related to a display process of the control device 200 according to the present embodiment will be described.

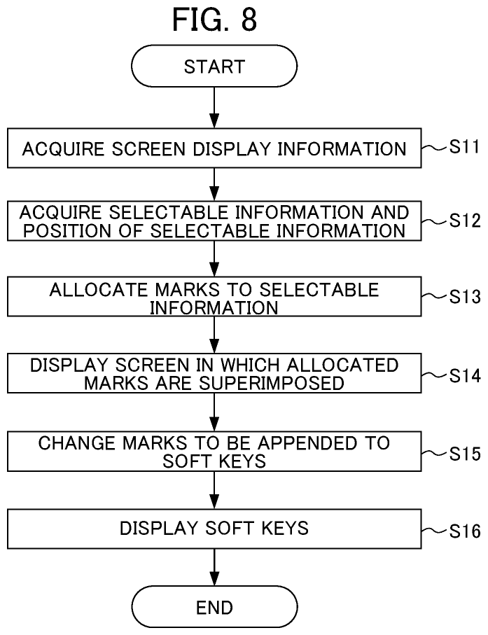

FIG. 8 is a flowchart illustrating a display process of the control device 200. The process flow illustrated herein is executed whenever a new screen is displayed according to a user's operation or a system process.

In step S11, the screen display information acquisition unit 210 acquires the screen display information on the screen displayed in the screen display region 20.

In step S12, the selectable information acquisition unit 220 acquires the selectable information on the screen and the position of the selectable information on the basis of the screen display information acquired in step S11.

In step S13, the mark allocation unit 230 allocates marks corresponding to the pieces of selectable information acquired in step S12.

In step S14, the screen display processing unit 240 displays a screen in which the marks allocated in step S13 are superimposed in the screen display region 20 on the basis of the position of the selectable information acquired in step S12.

In step S15, the soft key changing unit 250 changes the marks to be appended to the soft keys 31 according to the allocation in step S13.

In step S16, the soft key display processing unit 260 displays the soft keys 31 in the soft key display region 30.

As described above, the control device 200 according to the embodiment acquires screen display information on a screen displayed in the screen display region 20 and acquires selectable information on the screen and the position of the selectable information on the basis of the acquired screen display information. The control device 200 allocates marks corresponding to the acquired selectable information and displays a screen in which the allocated marks are superimposed in the screen display region 20. The control device 200 changes the marks to be appended to the soft keys 31 according to the allocation and displays the soft keys 31 to which the marks are appended in the soft key display region 30.

In this way, when the user presses the hard key 40 corresponding to the soft key 31, the control device 200 displays the selectable information of the marks allocated to the soft key 31 corresponding to the pressed hard key 40 on the display device 100. In the display device 100 that does not have a mouse or a touch panel, the user can perform an easily operation of pressing the hard key 40 once. By enabling information on a screen to be selected, it is possible to reduce the number of operations and improve the operability of the control device 200.

While an embodiment has been described, the control device 200 is not, limited to the above-described embodiment but may include modifications and improvements within a range where the object can be attained.

### Modification 1

In the above-described embodiment, although the control device 200 displays marks correlated with selectable information when the selectable information is present on a screen, there is no limitation thereto. For example, as illustrated in FIG. 2 and the like, when marks are displays constantly, information displayed on the screen may be hidden. The screen display processing unit 240 may display or do not display marks using a key input by the user such as pressing of a prescribed hard key 40 as a trigger.

In an embodiment, the functions included in the control device 200 can be realized by hardware, software or a combination thereof. Here, being realized by software means being realized when a computer reads and executes a program.

The programs can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM: (Erasable PROM), a flash ROM, and a RAM (Random Access Memory)). The programs may be supplied to a computer via various types of transitory computer readable media. Examples of the transitory computer readable media include electric signals, optical signals and electromagnetic waves. A transitory computer readable medium can provide programs to a computer through a wired communication path such as an electrical cable, optical fiber, or the like or a wireless communication path.

A step of describing the programs to be recorded on the recording medium includes processing that is performed in a parallel or an independent manner although the processing is not necessarily performed in a time series manner as well as processing that is performed in a time series manner according to the order.

In other words, the control device and the control method according to the present disclosure may employ various embodiments having the following configurations.

(1) A control device 200 of the present disclosure is a control device that controls display of a display device 100 displaying soft keys 31 for operating the control device that controls an industrial machine and having hard keys 40 disposed to correspond to the soft keys 31 to select the soft keys 31, including: a screen display information acquisition unit 210 that acquires screen display information on a screen displayed on the display device 100; a selectable information acquisition unit 220 that acquires selectable information which can be selected on the screen displayed on the display device 100 and a position of the selectable information on the basis of the acquired screen display information; a mark allocation unit 230 that allocates marks corresponding to respective pieces of acquired selectable information; a screen display processing unit 240 that displays the screen in which the marks allocated on the basis of the position of the selectable information are superimposed on the display device 100; a soft key changing unit 250 that changes marks to be appended to the soft keys 31 according to the allocation by the mark allocation unit 230; and a soft key display processing unit 260 that displays the soft keys 31 on the display device 100, wherein when the hard key 40 corresponding to the soft key 31 is pressed, the selectable information corresponding to the mark appended to the soft key 31 is displayed on the display device 100.

According to the control device 200, it is possible to perform operations easily in the display device 100 that does not have a mouse, a touch panel, or the like.

(2) The mark allocation unit 230 may allocate different marks for the respective pieces of selectable information depending on the number and positions of pieces of selectable information, and the soft key changing unit 250 may change marks to be appended to the soft keys 31 depending on the number of pieces of selectable information.

By doing so, even when a plurality of pieces of selectable information are present on the screen, it is possible to reduce the number of operations and improve the operability of the control device 200.

(3) The screen display processing unit 240 may display or may not display the marks in the screen when a prescribed hard key 40 is pressed.

By doing so, it is possible to avoid information being displayed on the screen from being hidden by marks.

(4) The selectable information may include at least any one of hyperlink information and a user interface (UI) control.

By doing so, even when at least any one of a hyperlink and a UI control is included in the screen and switching of the screen, expansion of a list box, or expansion of a tree is performed, it is possible to reduce the number of operations and improve the operability of the control device 200.

(5) When the hard key 40 corresponding to the soft key 31 to which the mark correlated with the selectable information is appended is pressed, the screen display processing unit 240 may move a cursor to the selectable information.

By doing so, it is possible to facilitate input to a text box as the selectable information.

(6) A control method of the present disclosure is a control method for controlling display of a display device 100 displaying soft keys 31 for operating the control device 200 that controls an industrial machine and having hard keys 40 disposed to correspond to the soft keys 31 to select the soft keys 31, the method being realized a computer and including: acquiring screen display information on a screen displayed on the display device 100; acquiring selectable information which can be selected on the screen displayed on the display device 100 and a position of the selectable information on the basis of the acquired screen display information; allocating marks corresponding to respective pieces of acquired selectable information; displaying the screen in which the marks allocated on the basis of the position of the selectable information are superimposed on the display device 100; changing marks to be appended to the soft keys 31 according to the allocation of the marks; and displaying the soft keys 31 on the display device 100, wherein when the hard key 40 corresponding to the soft key 31 is pressed, the selectable information corresponding to the mark appended to the soft key 31 is displayed on the display device 100.

According to the control method, the same advantages as in (1) are obtained.

### EXPLANATION OF REFERENCE NUMERALS

31(1) to 31(10): Soft key
40(1) to 40(10): Hard key
100: Display device
200: Control device
210: Screen display information acquisition unit
220: Selectable information acquisition unit
230: Mark allocation unit
240: image display processing unit
250: Soft key changing unit
260: Soft key display processing unit

What is claimed is:

1. A control device that controls display of a display device displaying soft keys for operating the control device that controls an industrial machine and having hard keys disposed to correspond to the soft keys to select the soft keys, comprising:
a screen display information acquisition unit that acquires screen display information on a screen displayed on the display device;
a selectable information acquisition unit that acquires selectable information which can be selected on the screen displayed on the display device and a position of the selectable information on the basis of the acquired screen display information;
a mark allocation unit that allocates marks corresponding to respective pieces of acquired selectable information;
a screen display processing unit that displays the screen in which the marks allocated on the basis of the position of the selectable information are superimposed on the display device;
a soft key changing unit that changes marks to be appended to the soft keys according to the allocation by the mark allocation unit; and
a soft key display processing unit that displays the soft keys on the display device, wherein
when the hard key corresponding to the soft key is pressed, the selectable information corresponding to the mark appended to the soft key is displayed on the display device.

2. The control device according to claim 1, wherein the mark allocation unit allocates different marks for the respective pieces of selectable information depending on the number and positions of pieces of selectable information, and
the soft key changing unit changes marks to be appended to the soft keys depending on the number of pieces of selectable information.

3. The control device according to claim 1, wherein the screen display processing unit displays or does not display the marks in the screen when a prescribed hard key is pressed.

4. The control device according to claim 1, wherein the selectable information includes at least any one of hyperlink information and a user interface control.

5. The control device according to claim 4, wherein when the hard key corresponding to the soft key to which the mark correlated with the selectable information is appended is pressed, the screen display processing unit moves a cursor to the selectable information.

6. A control method for controlling display of a display device displaying soft keys for operating the control device that controls an industrial machine and having hard keys disposed to correspond to the soft keys to select the soft keys, the method being realized by a computer and comprising:
acquiring screen display information on a screen displayed on the display device;
acquiring selectable information which can be selected on the screen displayed on the display device and a position of the selectable information on the basis of the acquired screen display information;
allocating marks corresponding to respective pieces of acquired selectable information;
displaying the screen in which the marks allocated on the basis of the position of the selectable information are superimposed on the display device;
changing marks to be appended to the soft keys according to the allocation of the marks; and
displaying the soft keys on the display device, wherein
when the hard key corresponding to the soft key is pressed, the selectable information corresponding to the mark appended to the soft key is displayed on the display device.
